(19) United States
(12) Patent Application Publication
(10) Pub. No.: US 2014/0251390 A1
(43) Pub. Date: Sep. 11, 2014

(54) Pressure Washer With Parallel Flow Soap Dispensing

(71) Applicant: GENERAC POWER SYSTEMS, INC., Waukesha, WI (US)

(72) Inventors: Mir Khan, Kenosha, WI (US); Greg Wischstadt, Wales, WI (US); David Serdynski, Waukesha, WI (US)

(73) Assignee: Generac Power Systems, Inc., Waukesha, WI (US)

(21) Appl. No.: 13/785,586

(22) Filed: Mar. 5, 2013

(51) Int. Cl. B08B 3/02

(52) U.S. Cl. CPC B08B 3/024
USPC 134/99.2; 134/184; 29/428

(57) ABSTRACT

A pressure washing system that includes a pump configured to generate a pressurized fluid stream and a wand that is connectable to the pressurized discharge of the pump. The wand includes a trigger and a nozzle that are exposed to the pressurized fluid path. The wand includes a treatment fluid path that is isolated from the pump pressurized fluid path. A reservoir configured to receive a treatment agent is disposed in the treatment fluid path and is connected between the water source and an outlet proximate the nozzle. A control is connected to the wand proximate the trigger to allow selective introduction of treatment agent contained in the reservoir to be introduced into the pressurized fluid flow downstream of the nozzle.

### FIELD OF THE INVENTION

The present invention relates generally to pressure washer systems, and in particular, to a dispensing system for introducing a cleaning agent proximate the discharge nozzle of the wand.

### BACKGROUND OF THE INVENTION

Pressure washers generally include a motor or engine that is operatively connected to a water pump. A high pressure hose connects a wand to a discharge side of the water pump. The wand commonly includes a pistol grip or the like that includes a trigger whose actuation effects discharge of a high-pressure water stream from the nozzle. Both the simplicity of operation and effectiveness associated with using such devices has made pressure washers a staple for various residential and commercial cleaning and surface preparation tasks. Understandably, many cleaning and surface preparation operation are best carried out with the use of extraneous cleaning or surface treatment agents. For instance, many deck and fence cleaning agents, automotive and/or fiberglass soaps, concrete cleaners, excreta, are commercially available and tailored to improve the efficiency of the particular cleaning operation. To better effectuate the cleaning or surface preparation operations, many power washers are configured for use with such soaps or agents.

Such agents are commonly introduced either via a high-pressure injector that introduces the agent to the pressurized water-stream downstream of the pump or a low-pressure injector that introduces the agent to the water-stream before feed water enters the pump. Each injection methodology is susceptible to alternate drawbacks. For instance, some chemical agents can damage the pressure pump such that such agents must be introduced downstream of the pump or into the pressurized water flow. Providing high pressure injection of the agents also requires that the cleaning agent delivery be constructed to withstand the pressures associated with operation at such pressures. Additionally, the structures associated with the wand can also be damaged by the flow of the pressurized mix of cleaning agent and water to the discharge nozzle.

The mixing properties of still other cleaning agents may dictate the best suitable implantation of the same. For instance, it may periodically be desirable to generate foam during the cleaning or surface preparation activities and introducing the agents upstream and/or downstream of the pump can adversely affect the ability of the pressure washer to generate a desired amount of foaming.

Still other systems can include a venturi structure that is oriented and constructed to generate a pressure differential in either the pressurized fluid flow or the agent flow such that a desired amount of agent can be drawn into the pressurized flow as a function of a fluid flow past or through the venturi. The volume of agent flow can be undesirably manipulated by undesired or unintended alterations to the shape and/or orientation of the venturi relative to the fluid flow. Furthermore, changing of the nozzle associated with the wand and/or manipulation of the water pump is often required to achieve the desired cleaning and/or foaming action. As such, current pressure washer cleaning agent systems do not readily lend themselves to expedient switching between applications that include the introduction of a cleaning or treatment agent and those applications wherein only a pressurized water flow is desired.

Therefore, there is a need for a pressure washing system that can be conveniently configured for use with and without supplemental cleaning or surface treatment agents.

### SUMMARY OF THE INVENTION

The present invention provides a pressure washing system that overcomes one or more of the drawbacks mentioned above. A pressure washing system according to one aspect of the invention includes a pump configured to generate a pressurized fluid stream and a wand that is connectable to the pressurized side of the pump. The wand includes a trigger and a nozzle that are exposed to the pressurized fluid path such that actuation of the trigger results in discharge of the pressurized stream from the nozzle. The wand includes a treatment fluid path that is isolated from the pressurized fluid path. A reservoir is configured to receive a treatment agent and is disposed in the treatment fluid path so as to be connected between a non-pressurized side of the pump and an outlet proximate the nozzle. A control is connected to the wand proximate the trigger and allows the treatment agent contained in the reservoir to selectively be introduced into the pressurized fluid flow downstream of the nozzle. Such a construction allows user controlled introduction of the cleaning or surface treatment agents to the pressurized fluid flow and does so in a manner that does not adversely interfere with operation of the pressurization pump.

Another aspect of the invention that includes one or more features that are combinable with the above aspect discloses a pressure washing system having a pump with an inlet and an outlet. The inlet of the pump is configured to be connected to a water source and the outlet is configured to be connected to a wand that includes a trigger and a nozzle. The system includes a reservoir that is configured to receive a treatment agent such as soap. The reservoir has an inlet that is fluidly connected to the water source and an outlet that is proximate the nozzle. A control is connected to the wand proximate the trigger to selectively allow fluid communication between the water source and the inlet of the reservoir. Fluid communication between the reservoir and the water source facilitates introduction of the treatment agent to the pressurized fluid flow expelled from the nozzle.

Another aspect of the invention that can be combined with one or more of the features of the above aspects discloses a pressure washing system having a pump that is connectable between a water source and a wand. The system includes a first passage that is formed through the wand and terminates at a nozzle. The first passage is further defined as being interruptible by operation of a trigger assembly. A second passage is formed through the wand and has an inlet that is fluidly connectable to a reservoir and an outlet that is positioned proximate the nozzle. The outlet is further defined as being oriented to deliver the contents of the reservoir to a stream discharged from the nozzle.

Another aspect of the invention that is useable or combinable with one or more of the features of the above aspects discloses a method of forming a pressure washing system. The method includes providing a wand that has a first fluid path and a second fluid path. The first fluid path is defined as being fluidly connectable to a higher pressure side of a fluid pump and the second fluid path is defined as being connectable to a lower pressure side of the fluid pump. A trigger is provided to selectively interfere with communication of fluid along the first fluid path between the high pressure side of the fluid pump and a nozzle. A reservoir is provided and configured to be disposed in the second fluid path. A first portion of the second fluid path that is connectable to the lower pressure side of the fluid pump is isolated from a second portion of the second fluid path that is fluidly connected to atmosphere downstream of the nozzle such that the contents of reservoir can be introduced to the nozzle discharge stream without commingling with fluid in the first portion of the second fluid path.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated of carrying out the invention.

In the drawings:

FIG. 1 is a perspective view of a portable engine powered pressure washing device according to the present invention; and

FIG. 2 is a schematic representation showing the fluid circuits associated with operation of the pressure washing device shown in FIG. 1.

### DETAILED DESCRIPTION OF THE DRAWINGS

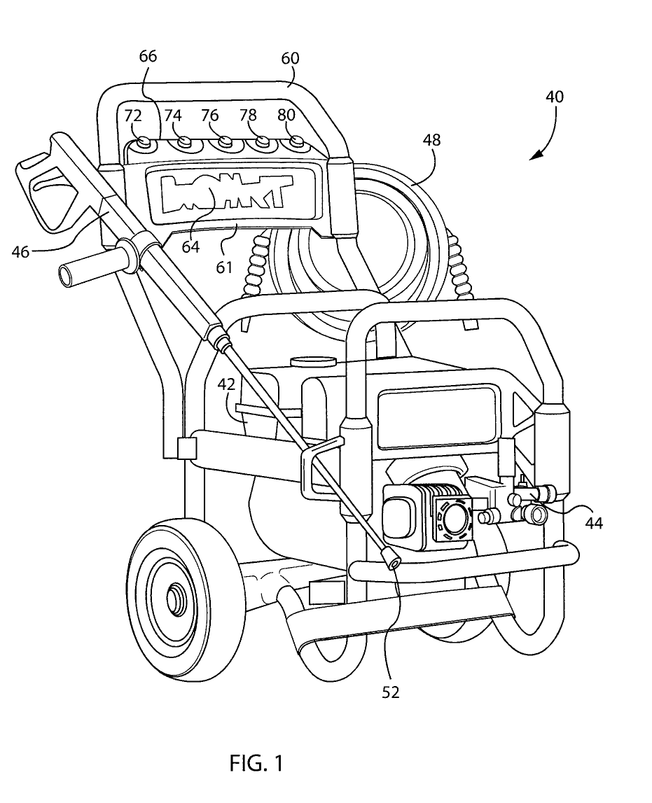

FIG. 1 shows a portable engine powered pressure washer 40 according to the present invention. As shown FIG. 1, pressure washer 40 includes an internal combustion engine 42 that is operationally connected to a pump 44. It is appreciated that one or more of the aspects disclosed herein may be applicable to power washer systems having other power sources, such as motor driven pumps, whereas other features or aspects of the proposed system are applicable only to engine powered power pressure washers. Those skilled in the art will readily appreciate the alternative uses of various aspect disclosed herein.

Engine 42 can be directly or indirectly (via a power transmission system such as a belt or other flexible drive member) coupled to pump 44. When engine 42 directly cooperates with pump 44 without supplemental power transmission systems, pump 44 can be considered a direct drive pump. It is appreciated that there a number of methodologies associated with generating a desired fluid pressure output associated with use of power washer 40. One methodology includes providing a pressure output of the pump that is a function of the operational revolutions per minute (rpm) of the pump and which is directly correlated to the operation speed or revolutions per minute (rpm) of the engine crankshaft. The higher the rpm of the pump, the higher the pump output pressure—assuming other system variables to be constant. In such a confirmation, the input rpm of the pump is controlled by the engine rpm by means of controlling the engine throttle such that, variable pressures can be provided at the pump output pressure via manipulation of the engine throttle or engine speed. The variable pressure output in conjunction with an engine speed selector dial allows one pressure washer to act as though it were capable of providing several different fixed operating pressures.

Another methodology for manipulating the pump discharge pressure delivered to the wand includes providing a variable setting regulator or bypass valve assembly associated with operation of the pump as is described further below. Such a configuration includes a valve assembly that is integral to the pump or disposed between the pump 44 and a wand 46 for communicating the pressured fluid flow to the wand 46 connected to pump 44. As explained further below, such an assembly includes a control or regulator associated with regulating the pressure flow communicated to the wand in a manner partially independent of engine operating speed. That is, such a regulator allows the delivery of fluid to wand 46 at variable pressures at or below a maximum output pressure associated with the available water source pressure and given operating conditions of engine 42.

Still referring to FIG. 1, wand 46 is connected to an output side of pump 44 via a hose 48. A trigger 50 that is supported by wand 46 is located at one end of wand 46. A discharge nozzle 52 is disposed at the opposite end of the wand 46. Nozzle 52 may be adjustable and/or replaceable to provide a desired spray pattern during operation of pressure washer 40. Pressure washer 40 preferably includes a chassis 54 having one or more wheels 56 and a handle 60 for improving the mobility of the unit to facilitate convenient transportation of pressure washer 40.

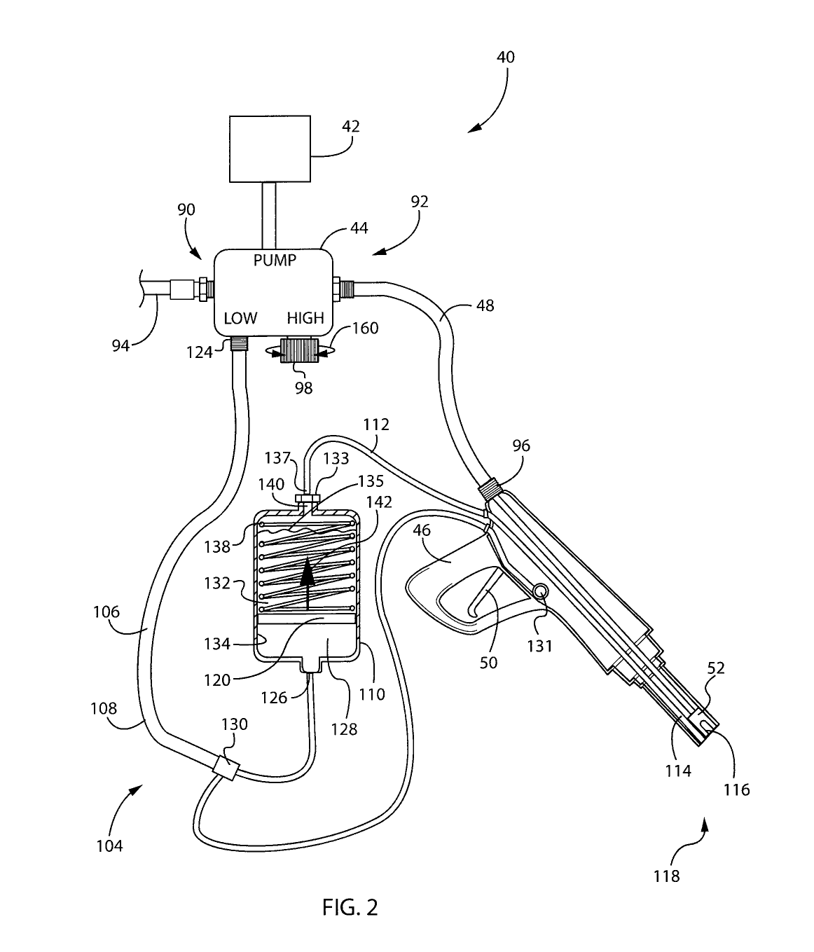

Pressure washer 40 can include a panel, bezel, or dashboard 61 that can include one or more instructional indicia 64 associated with the desired operation or intended use of pressure washer 40. Preferably, dashboard 61 includes one or more indicia that explain, either textually or pictographically, proper operation of pressure washer 40. Preferably, dashboard 60 includes one or more receptacles or mounting portions 66 associated with supporting replaceable or interchangeable tips or nozzles 72, 74, 76, 78, 80 associated with the desired use of pressure washer 40. As is readily understood, nozzles 72-80 are configured to interchangeably cooperate with the discharge end of wand 46 so as to replace nozzle 52. Alternatively, it is appreciated that nozzle 52 could be adjustable to provide more than one spray pattern. It is further appreciated that wand 46 may have integrated nozzles that are interchangeable and/or adjustable to allow various different functions including soaping via introduction of a detergent or other cleaning or treatment agent through an agent introduction system 104 as explained further below with respect to FIG. 2.

FIG. 2 is a schematic representation of the operational system of pressure washer 40 associated with communicating a pressurized stream of water through wand 46 and selectively introducing a treatment agent, such as soap, a cleaning agent, etc. to the pressurized flow sprayed from wand 46 for desired cleaning and surface treatment activities. As shown graphically in FIG. 2, engine 42 can be directly or indirectly operationally connected to pump 44. Pump 44 includes a low-pressure port or inlet side 90 and a high-pressure port, discharge side, or pump outlet 92. A feed water source 94, such as a garden hose, is connected between a water supply and inlet side 90 of pump 44. Operation of engine 42 drives pump 44 so as to generate a pressurized fluid flow at pump outlet 92.

Hose 48 extends between outlet 92 of pump 44 and is connected to a pressure flow water inlet 96 of wand 46. A dial 98 provides pressure regulation at pump 44 and can be operated to provide the desired pressure at wand 46, and particularly at nozzle 52, of available operating pressure generated at pump output 92 during operation of engine 42. Dial 98 is rotatable, as indicated by arrow 100, so as to provide the desired operating fluid or water pressure at output 92 and which is communicated therefrom to nozzle 52 during actuation of trigger 50. Preferably, pump 44 includes a bypass associated with the relative positioning of dial 98 to mitigate the generation of backpressure conditions at inlet 90 of pump 44. Although shown as being unitary with pump 44, is appreciated that the functionality of the fluid pressure regulation associated with dial 98 could be provided at alternate locations rather than being integral with pump 44 and/or provided as an engine operating speed control paradigm as disclosed above.

Power washer 40 includes an agent introduction system 104 that defines a second or alternate treatment agent or fluid path 106 between pump 44 and wand 46. Fluid path 106 includes a first portion 108 that extends between pump 44 and a reservoir or a canister 110 and a second portion 112 that extends between canister 110 and a location or outlet 114 that is downstream but proximate an outlet 116 associated with nozzle 52 connected at a discharge end 118 of wand 46. As explained further below, canister 110 includes a movable piston 120 that maintains fluid isolation between first portion 108 and second portion 112 of fluid path 106. As explained further below, water communicated from source 94 through first portion 108 of fluid path 106 is directed to a first side of piston 120 and increases the pressure associated with the first side of piston 120. The increase in pressure of the water side of agent introduction system 104 increases the pressure associated with a second or agent side of piston 120 such that the agent contents of canister 110 associated with second portion 112 of fluid path 106 can be selectively forced from the canister and delivered to a location proximate but downstream of nozzle for reasons further discussed below.

First portion 108 of fluid path 106 includes an inlet 124 that is fluidly connected to the low-pressure or inlet side 90 of pump 44 and an outlet 126 that is fluidly connected to a first chamber 128 associated with canister 110. A valve 130 is disposed between inlet 124 and outlet 126 and operatively connected to a user input or control 131 that is preferably connected to wand 46 and more preferably oriented proximate trigger 50. Such a construction allows the user to selectively designate a pressurized spray operation, agent introduction proximate nozzle 52, and/or concurrent spray of the pressurized water stream and introduction of the agent. Input 130 is configured to manipulate the orientation of valve 130 so as to allow or prevent fluid communication between inlet 124 and first chamber 128 of canister 110. When valve 130 is open, first chamber 128 is subjected to the low pressure signal associated with feed water 94 to dispense agent from canister 110 and when valve 130 is closed, canister 110 is isolated from the pressure signal associated with input 124 so as to suspend introduction of the agent to the spray expelled from nozzle 52.

As mentioned above, canister 110 includes a second chamber 132 that is fluidly isolated from first chamber 128 by piston 120. A removable cap 133 is associated with an opening 140 of second chamber 132. Cap 133 removable cooperates with opening 140 to allow the user to place a treatment agent 135 in second chamber 132 when use of a surface treatment agent is desired. Although cap 133 is shown as providing an inlet 137 to second portion 112 of fluid path 106, it is appreciated that inlet 137 and cap 133 could be provided as separate structures associated with accessing second chamber 132.

Piston 120 slidably cooperates with an interior wall 134 of canister 110 in a sealed manner so as to prevent fluid exchange between first chamber 128 and second chamber 132. Alternatively, piston 120 could include a bypass intended to allow some water to enter second chamber 132 but in a manner that maintains a pressure differential between first chamber 128 and second chamber 132. Such a construction would facilitate the desired translation of piston 120 relative to canister 110 to force agent 135 from canister 110 when valve 130 is open while allowing the water that bypasses piston 120 to dilute or dissolve different treatment agents 135. Such a configuration would also extend the operational period associated with consumption of a given agent 135 thereby reducing the frequency with which treatment agent 135 must be replenished.

A biasing means, such as a spring 138, is disposed in the second chamber 132 and biases piston 120 toward first chamber 128. Said in another way, spring 138 counteracts displacement of piston 120 in the direction, indicated by arrow 142, that reduces the size of second chamber 132 in response to introduction of the pressure signal from inlet 124 via operation of valve 130 upon actuation of control 131. Closing valve 30 via manipulation of control 131 suspends delivery of agent 135 to outlet 14 and maintains a pressure necessary in second chamber 132 associated with near immediate discharge of agent 135 from outlet 114 during subsequent opening of valve 130.

Upon completion of a desired treatment process, suspension of the pressure associated with feed water flow 94 and opening of valve 130 allows spring 138 to return to an at rest position that reduces the volume of first chamber 128 and increases the volume of second chamber 132 thereby returning agent introduction system 104 to a configuration suitable for subsequent operation of power washer 40 and/or replenishing of agent 135. Alternatively, it is also appreciated that valve 130 be configured to allow the release of the pressure introduced to first chamber 128 with each actuation and de-actuation cycle of control 131. Regardless of the specific methodology, agent introduction system 104 is configured to allow the user to selectively introduce a cleaning or treatment agent 135 to the pressurized fluid spray dispelled from nozzle 52 and in a manner that does not require the generally more complex structural requirements or complications associated with introducing and/or mixing the treatment agent with the high pressure fluid stream delivered and/or generated by pump 44 prior to the egress of the mixed solution at nozzle 52.

Although canister 110 is shown schematically in FIG. 2 as being separate from either the base unit associated with supporting engine and pump 42, 44 as well as wand 46, it is appreciated that canister 110 could be supported by either structure. When integrated with wand 46, it is appreciated that the shape and contour of wand could be provided in a desired “gun” shape form factor and that the volumes associated with canister 110 could be integrated therein. Alternatively, it is appreciated that the fluid paths associated with agent introduction system 104 removably cooperate with the base unit and wand 46 to allow separation and storage of agent introduction system 104 during non-use of the same. Segregation of the high pressure water spray fluid associated with the first fluid path extending between outlet 92 of pump 44 and nozzle 52 and the lower operating pressure associated with second or treatment agent fluid path 106 provides a power washer 40 that can be conveniently configured for multiple alternate uses.

Many changes and modifications could be made to the invention without departing from the spirit thereof. The scope of these changes will become apparent from the appended claims.

1. A pressure washing system comprising:
a pump having an inlet that is configured to be connected to a water source and an outlet;
a wand connected to the outlet of the pump and having a trigger and a nozzle;
a reservoir configured to receive a treatment agent, the reservoir having an inlet fluidly connected to the water source and an outlet proximate the nozzle; and
a control connected to the wand proximate the trigger to selectively allow fluid communication between the inlet of the reservoir and the water source.

2. The pressure washing system of claim 1 further comprising a diaphragm in the reservoir that maintains fluid isolation between the inlet and the outlet of the reservoir.

3. The pressure washing system of claim 2 wherein the diaphragm is further defined as a piston.

4. The pressure washing system of claim 3 further comprising a spring that biases movement of the piston.

5. The pressure washing system of claim 1 further comprising an engine or a motor connected to the pump.

6. The pressure washing system of claim 1 wherein the control is further defined as a push button.

7. The pressure washing system of claim 1 further comprising a valve disposed between the inlet of the reservoir and the water source and connected to the control.

8. A pressure washing system comprising:
a pump connectable between a water source and a wand;
the wand defining 1) a first passage formed through the wand and terminating at a nozzle, the first passage being interruptible by operation of a trigger assembly and 2) a second passage formed through the wand, the second passage having an inlet fluidly connectable to a reservoir and an outlet positioned proximate the nozzle and oriented to deliver contents of the reservoir to a stream discharged from the nozzle.

9. The pressure washing system of claim 8 wherein the reservoir is connected to the water source.

10. The pressure washing system of claim 9 further comprising a piston disposed in the reservoir and movable to manipulate a volume of a portion of the reservoir exposed to the second passage.

11. The pressure washing system of claim 10 further comprising a spring disposed in the reservoir and oriented to bias the piston in a direction that increases the volume of the portion of the reservoir exposed to the second passage.

12. The pressure washing system of claim 9 further comprising a valve connected between the reservoir and the water source.

13. The pressure washing system of claim 12 further comprising a control connected to the valve and positioned proximate the trigger assembly.

14. A method of forming a pressure washing system comprising:
providing a wand with a first fluid path and a second fluid path, the first fluid path being fluidly connectable to a higher pressure side of a fluid pump and the second fluid path being connectable to a lower pressure side of the fluid pump;
providing a trigger to selectively interfere with communication of fluid along the first fluid path between the high pressure side of the fluid pump and a nozzle;
providing a reservoir configured to be disposed in the second fluid path; and
isolating a first portion of the second fluid path that is connectable to the lower pressure side of the fluid pump from a second portion of the second fluid path that is fluidly connected to atmosphere downstream of the nozzle.

15. The method of claim 14 further comprising providing a movable piston in the reservoir and whose position relative to the reservoir manipulates a volume of the second portion of the second fluid path.

16. The method of claim 15 further comprising biasing the movable piston in a direction the increases the volume of the second portion of the second fluid path.

17. The method of claim 14 further comprising providing a valve in the first portion of the second fluid path to selectively isolate the reservoir from the lower pressure side of the fluid pump.

18. The method of claim 17 further comprising providing a control for manipulating the orientation of the valve between an open condition and a closed condition.

19. The method of claim 18 further comprising positioning the control proximate the trigger so that an operator can concurrently interact with the control and the trigger.

20. The method of claim 14 further comprising providing one of a motor or an engine to power operation of the pump.
